(19) United States
(12) Patent Application Publication
(10) Pub. No.: US 2008/0225546 A1
(43) Pub. Date: Sep. 18, 2008

(54) VEHICLE HEADLAMP

(75) Inventors: Chia-Te Lin, Hsinchu County (TW); Li-Wei Tseng, Taipei (TW)

Correspondence Address: J C PATENTS, INC., 4 VENTURE, SUITE 250, IRVINE, CA, 92618, US

(73) Assignee: AMA PRECISION INC., Taipei (TW)

(21) Appl. No.: 11/854,355

(22) Filed: Sep. 12, 2007

(30) Foreign Application Priority Data
Mar. 13, 2007 (TW) 96108540

(51) Int. Cl. B60Q 1/00; F21V 31/00; F21V 29/00

(52) U.S. Cl. 362/547; 362/267

(57) ABSTRACT

A vehicle headlamp is provided. The vehicle headlamp includes a lampshade, a lamp base provided at the lampshade, a light source module provided at the lamp base, a light source adjusting mechanism connected between the lampshade and the lamp base and a heat dissipation module. Wherein, lampshade has an opening, and the light source adjusting mechanism can adjust the relative position between the lampshade and the lamp base. In addition, the heat dissipation module provided between the light source module and the lamp base can extend to the external side of the lampshade via the opening.

### CROSS-REFERENCE TO RELATED APPLICATION

This application claims the priority benefit of Taiwan application serial no. 96108540, filed on Mar. 13, 2007. All disclosure of the Taiwan application is incorporated herein by reference.

### BACKGROUND OF THE INVENTION

1. Field of the Invention

The present invention relates to a vehicle headlamp and, more particularly, to a vehicle headlamp having a heat dissipation module.

2. Description of the Related Art

In the design field of the vehicle headlamp, to meet the requirement for the optical shape of the light produced by the vehicle headlamp, most of the headlamps assembled in the vehicle are provided with a light source adjusting mechanism, so that after the vehicle headlamp is assembled, the angle of the headlamp can be manually adjusted to produce the optical shape complying with the requirements. FIG. 1 is a schematic diagram showing a conventional vehicle headlamp. Please refer to FIG. 1. A conventional vehicle headlamp 100 includes a lampshade 110, a lamp base 120, a light source 130 provided at the lamp base 120, and a light source adjusting mechanism 140 connected between the lampshade 110 and the lamp base 120. Wherein, the light source adjusting mechanism 140 is suitable to adjust the relative position between the lampshade 110 and the lamp base 120, so that when the light emitted by the light source 130 reaches the external side of the lampshade 110, the optical shape can comply with the requirements.

From the above, since the light emitting diode (LED) has the advantages of small dimension and long lifespan, most light source 130 of the vehicle headlamp 100 is LED light source. The LED light source applied in the vehicle headlamp 100 has a higher heat emitting power, so that the temperature in the vehicle headlamp 100 is easily to be overheated.

### BRIEF SUMMARY OF THE INVENTION

One preferred embodiment of the present invention provides a vehicle headlamp to solve the problem of heat dissipation of the light source module.

To achieve the above or other objectives, the vehicle headlamp of one preferred embodiment of the present invention includes a lampshade, a lamp base provided at the lampshade, a light source module provided at the lamp base, a light source adjusting mechanism connected between the lampshade and the lamp base and a heat dissipation module, wherein the lampshade has an opening, and the light source adjusting mechanism can adjust the relative position between the lampshade and the lamp base. In addition, the heat dissipation module provided between the light source module and the lamp base can extend to the external side of the lampshade via the opening.

In one embodiment of the present invention, the heat dissipation module includes a heat dissipation base, a heat pipe and a fins assembly. The heat dissipation base is provided between the light source module and the lamp base, and the heat pipe has a first end and a second end. The first end is provided through the heat dissipation base, and the second end extends to the external side of the lampshade via the opening. The fins assembly is provided at the second end.

In one embodiment of the present invention, the vehicle headlamp further includes a support which is provided through the fins assembly and is fixed at the lamp base.

In one embodiment of the present invention, the light source module includes a circuit board and a light source provided at the circuit board. A reflector is provided on the lamp base, and the light emitted by the light source is suitable to reach the external side of the lampshade via the reflector.

In one embodiment of the present invention, the light source is a light emitting diode (LED).

In one embodiment of the present invention, the vehicle headlamp further includes a waterproof adhesive strip provided between the lampshade and the lamp base.

In the present invention, a heat dissipation module is provided between the light source module and the lamp base to dissipate the heat of the light source module, wherein a part of the heat dissipation module extends to the external side of the lampshade via the opening. In this way, the heat produced by the light source module can be dissipated to the surroundings by the heat dissipation module and keep the heat convection with the outside surroundings, so that the light source module can be in a normal working environment without overheated.

### Beneficial Effect:

In the present invention, a heat dissipation module is provided between the light source module and the lamp base to dissipate the heat of the light source module, wherein a part of the heat dissipation module extends to the external side of the lampshade via the opening, so that the heat produced by the light source module can have the convection to the surroundings by the heat dissipation module, and the light source module can be in a normal working status. In addition, after the vehicle headlamp of the present invention is provided with a heat dissipation module, the light source adjusting mechanism still can be adjusted to the appropriate position of the lampshade related to the lamp base effectively, so that the optical shape produced by the vehicle headlamp can comply with the requirements. That is, the vehicle headlamp of the present invention has both the advantages of high heat dissipation efficiency of the light source module and the easy operation of the light source adjusting mechanism.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional vehicle headlamp.

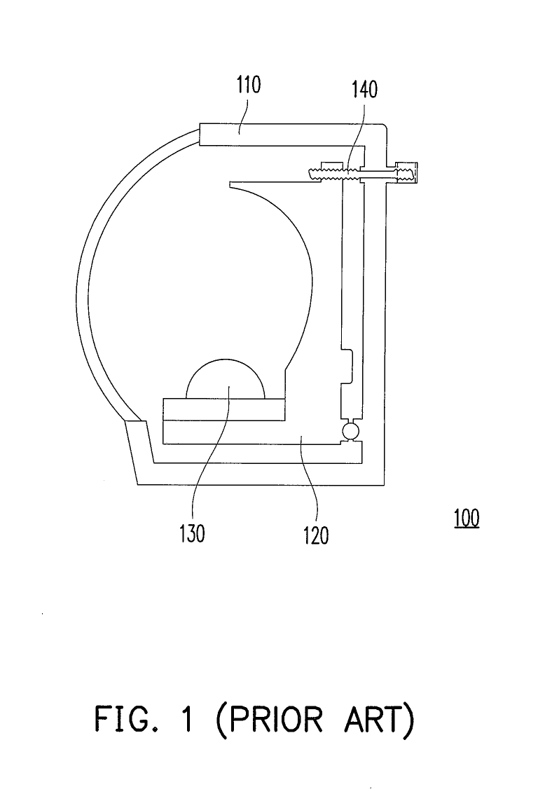

FIG. 2A is a schematic diagram showing a vehicle headlamp of one embodiment of the present invention.

FIG. 2B is a schematic diagram showing the vehicle headlamp of the embodiment after the lamp base shown in FIG. 2A rotates relatively to the lampshade.

### DETAILED DESCRIPTION OF THE EMBODIMENTS

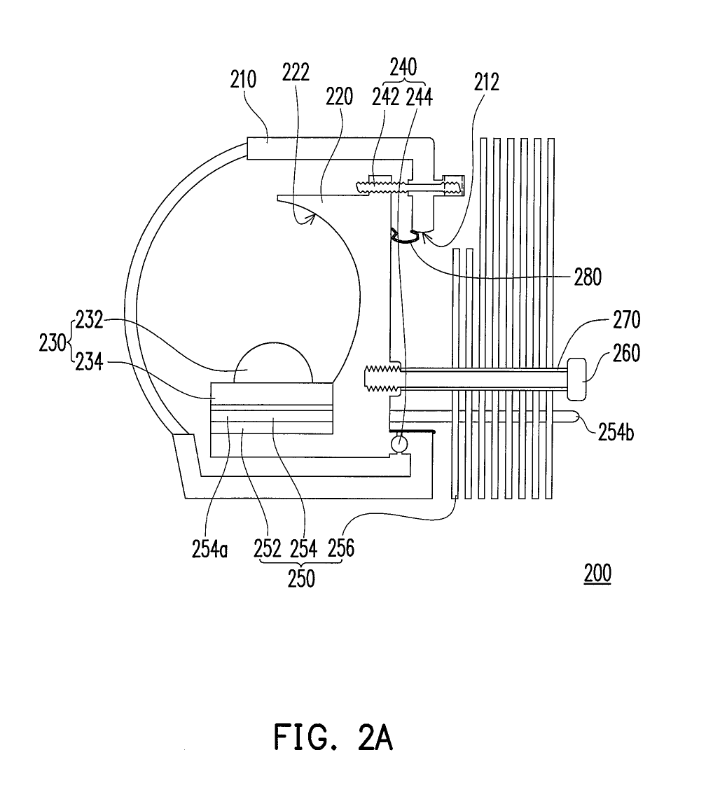

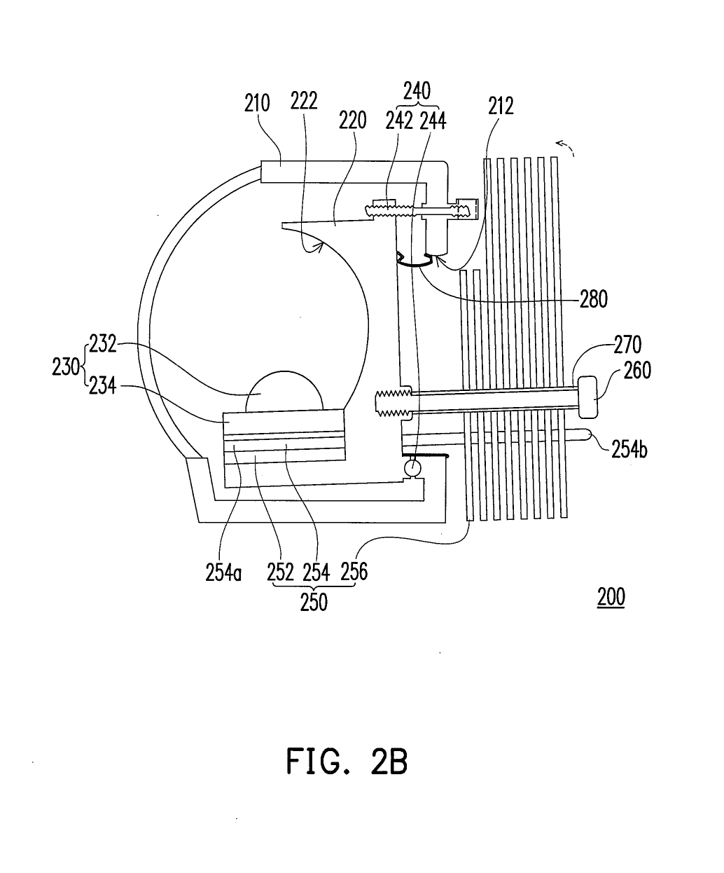

FIG. 2A is a schematic diagram showing a vehicle headlamp of one embodiment of the present invention. Please refer to FIG. 2A, the vehicle headlamp 200 of the embodiment includes a lampshade 210, a lamp base 220, a light source module 230, a light source adjusting mechanism 240 and a heat dissipation module 250, wherein the lamp base 220 is provided in the lampshade 210, and the light source module 230 is provided on the lamp base 220. In this way, the light source module 230 can be protected by the lampshade 210 and is not easy to be destroyed by the external force. In the embodiment, the light source module 230 is composed of a circuit board 234 and a light source 232. The light source 232 is, for example, a light emitting diode (LED). A reflector 222 is, for example, provided on the lamp base 220, and the light emitted by the light source 232 can be emitted to the external side of the lampshade 210 via the reflector 222.

In addition, the light source adjusting mechanism 240 is connected between the lampshade 210 and the lamp base 220 to adjust the appropriate position of the the lampshade 210 related to the lamp base 220, so that the vehicle headlamp 200 can produce the optical shape complying with the requirements. For example, the light source adjusting mechanism 240 of the embodiment is composed of an adjusting screw 242 and a ball joint 244, wherein the bottom of the lamp base 220 is connected to the lampshade by the ball joint 244, the top of the lamp base 220 is joined to the lampshade 210 by the adjusting screw 242. A user can rotate the lamp base 220 relatively to the lampshade 210 with the ball joint 244 as the pivot by rotating the adjusting screw 242 (Please refer to FIG. 2B which is a schematic diagram showing the vehicle headlamp of the embodiment after the lamp base shown in FIG. 2A rotates relatively to the lampshade.), so that the optical shape which is formed after the light emitted by the light source 232 reaches to the external side of the lampshade via the reflector 222 can comply with the requirements. Certainly, in other preferred embodiments, the light source 232 also can emit light to the external side of the lampshade 210 directly to form the optical shape complying with the requirements. There is no limitation thereon.

In addition, the heat dissipation module 250 of the embodiment is provided between the light source module 230 and the lamp base 220 and suitable to dissipate the heat for the light source module 230 to reduce the inner temperature of the vehicle headlamp 200. More specifically, in the embodiment, lampshade 210 has an opening 212, and the heat dissipation module 250 provided between the light source module 230 and the lamp base 220 can extend to the external side of the lampshade 210 via the opening 212 to dissipate the heat produced by the light source module 230 to the external side of the lampshade 210. The heat dissipation module 250 of the embodiment is described in detail hereinbelow.

According to the descriptions above, the heat dissipation module 250 of the embodiment mainly includes a heat dissipation base 252, a heat pipe 254 and a fins assembly 256. In the embodiment, the material of the heat dissipation base 252 is, for example, copper (Cu) or aluminum (Al) which has preferred heat conduction efficiency. The heat dissipation base 252 is provided between the light source module 230 and the lamp base 220. In addition, the heat pipe 254 has a first end 254a and a second end 254b. The first end 254a is provided through the heat dissipation base 252 and is closely against to the heat dissipation base 252. The second end 254b of the heat pipe 254 extends to the external side of the lampshade 210 via the opening 212. The fins assembly 256 is provided at the second end 254b of the heat pipe 254. In this way, the heat produced by the light source module 230 can be conducted to the heat pipe 254 by the heat dissipation base 252 and be conducted to the fins assembly 256 via the heat pipe 254. Since the fins assembly 256 has a large area for the heat convection with the surroundings, the heat produced by the light source module 230 can be dissipated to the surroundings effectively by the heat convection.

In the embodiment, since the heat dissipation module 250 is provided between the light source module 230 and the lamp base 220, when a user adjusts the light source adjusting mechanism 240, the heat dissipation module 250 also rotates with the lamp base 220. More specifically, in the embodiment, the opening 212 on the lampshade 210 has a proper open room, so that when the heat dissipation module 250 rotates with the lamp base 220, the heat pipe 254 does not interfere with the lampshade 210. That is, the provided heat dissipation module 250 does not affect the operation of the light source adjusting mechanism 240. In other words, the vehicle headlamp 200 can have not only the high heat dissipation efficiency of the light source module 230 but also the easy operation of the light source adjusting mechanism 240.

To make the heat dissipation module 250 be steadily provided between the light source module 230 and the lamp base 220, the vehicle headlamp 200 of the embodiment further can include a support 260 which is, for example, a retaining bolt. The retaining bolt is provided through the fins assembly 256 and is fixed at the lamp base 220, so that the heat dissipation module 250 can be joint tightly with the light source module 230. In addition, since the material of the support 260 can be the metal material with high conduction efficiency, and the support 260 and the fins assembly 256 are joint tightly in the embodiment, after the heat produced by the light source module 230 is conducted to the fins assembly 256 via the heat pipe 254, the support 260 can distribute the heat over each fin evenly, so that the efficiency of the heat convection between the fins assembly 256 and the surroundings can be promoted. In addition, in the embodiment, a pipe fitting 270 can be provided through the fins assembly 256 first, and then the support 260 is inserted into the pipe fitting 270 and fixed in the lamp base 220, which can also make the heat dissipation module 250 be steadily provided between the light source module 230 and the lamp base 220.

In addition, in the embodiment, a waterproof adhesive strip 280 also can be provided between the lampshade 210 and the lamp base 220 to protect the inside of vehicle headlamp 200 from the vapor or the dust to avoid the inner wiring of the vehicle headlamp be affected with damp. In other words, the vehicle headlamp 200 of the embodiment satisfies the requirements of a waterproof vehicle headlamp.

Although the present invention has been described in considerable detail with reference to certain preferred embodiments thereof, the disclosure is not for limiting the scope of the present invention. Persons having ordinary skill in the art may make various modifications and changes without departing from the scope and spirit of the present invention. Therefore, the scope of the appended claims should not be limited to the description of the preferred embodiments described above.

What is claimed is:

1. A vehicle headlamp comprising:
a lampshade having an opening;
a lamp base provided in the lampshade;
a light source module provided at the lamp base;
a light source adjusting mechanism connected to the lampshade and the lamp base; and
a heat dissipation module which is provided between the light source module and the lamp base and extends to the external side of the lampshade via the opening.

2. The vehicle headlamp according to claim 1, wherein the heat dissipation module comprises a heat dissipation base, a heat pipe and a fins assembly, and the heat dissipation base is provided between the light source module and the lamp base, the heat pipe has a first end provided through the heat dissipation base and a second end extending to the external side of the lampshade via the opening, and the fins assembly is provided at the second end.

3. The vehicle headlamp according to claim 2, wherein the vehicle headlamp further comprises a support, and the support is provided through the fins assembly and fixed at the lamp base.

4. The vehicle headlamp according to claim 1, wherein the light source module comprises a circuit board and at least a light source provided at the circuit board, and a reflector is provided on the lamp base, and the light emitted from the light source is suitable to reach the external side of the lampshade via the reflector.

5. The vehicle headlamp according to claim 4, wherein the light source is a light emitting diode.

6. The vehicle headlamp according to claim 1, wherein the vehicle headlamp further comprises at least a waterproof adhesive strip provided between the lampshade and the lamp base.
